(19) United States
(12) Patent Application Publication
(10) Pub. No.: US 2007/0131005 A1
(43) Pub. Date: Jun. 14, 2007

(54) SYSTEMS AND METHODS FOR PROVIDING UNIVERSAL SECURITY FOR ITEMS

(75) Inventor: Thomas J. Clare, Media, PA (US)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(73) Assignee: CHECKPOINT SYSTEMS, INC., Thorofare, NJ (US)

(21) Appl. No.: 11/609,148

(22) Filed: Dec. 11, 2006

Related U.S. Application Data
(60) Provisional application No. 60/750,194, filed on Dec. 14, 2005.

(51) Int. Cl. E05B 65/12; G08B 13/14; G08C 19/00

(52) U.S. Cl. 70/256; 340/825.72; 340/572.9

(57) ABSTRACT

A lock system having a remote actuating device, e.g., a portable member arranged to wirelessly transmit a wireless signal, and a passive lock for receiving that signal. The lock includes an acuatable trigger mechanism and a control circuit. The control circuit receives the wireless signal, which powers it. The control circuit also determines if the wireless signal is appropriate to unlock the lock, whereupon it produces a trigger signal. The trigger mechanism is responsive to the trigger signal to actuate and enable the lock to be opened.

### CROSS-REFERENCE TO RELATED APPLICATIONS

This utility application claims the benefit under 35 U.S.C. § 119(e) of Provisional Application Ser. No. 60/750,194 filed on Dec. 14, 2005 entitled SYSTEMS AND METHODS FOR PROVIDING UNIVERSAL SECURITY FOR ITEMS and whose entire disclosure is incorporated by reference herein.

### BACKGROUND OF THE INVENTION

1. Field of Invention

This invention relates generally to security systems and more particularly to locks, locking systems and methods for protecting items via locks and for providing access control via locks.

2. Description of Related Art

The protection of products from theft anywhere in the retail supply chain from the manufacturer to the retailer is a major concern and a multibillion dollar market. This theft or product “shrinkage” can be by members of public at large and/or by employees of the business.

In fact, employee theft is likely to be a greater problem, than thefts by others. To address the product shrinkage issue various security approaches are in use alone or in combination with one another. For example, electronic video surveillance is a common technique employed to deter theft. While generally suitable for their intended purposes, such systems are not without their drawbacks. In this regard, such systems are relatively expensive. Moreover, and quite significantly for maximum utility they are labor intensive, i.e., the operate best if a human being is present at the video terminals to constantly monitor the video received from the various cameras, since that is the only way to detect the theft as it is occurring. While many businesses do make use of video surveillance cameras, due to financial restraints they may not be able to provide staff to constantly monitor the cameras. Instead, many retail businesses merely rely upon videotape to record the events, for review later, e.g., after a theft incident has arisen. While that approach may result in determining the identity of the perpetrator of the theft, it doesn't prevent the theft.

Other systems for preventing theft in use today entail use of security tags on the items to be protected. For example, in the retail environment, e.g., a store, it is a common practice to tag the items to be sold with an EAS (electronic article surveillance) tag or an RFID (radio frequency identification) tag to ostensibly prevent that item from being pilfered. Some types of EAS tags comprise a sticker or label including a deactivatable resonant circuit, which if not deactivated when the tagged item is paid for and checked out, will cause an alarm signal to be produced when the item bearing the tag is brought past an antenna system at the exit of the store. Deactivation of many types of EAS tags is typically accomplished by the application of a high voltage signal to the tag's resonant circuit at the checkout counter to prevent it from resonating in the field of the antenna system. Other EAS tags may be in the form of what are called “hard tags.” A hard tag can be thought of as being closely related to a lock since it basically comprise a device which is releasably secured onto the item to be protected, so that it is resistant to removal, and which includes means that will produce an alarm when the tag is brought past the antenna system at the exit of the store if the tag has not be removed from the item. Hard tags typically include a plastic housing made up of two cooperating housing components which together form an actuatable locking mechanism. One component contains a pin and the other component a magnetically operated, spring loaded ball clutch. The pin of the one component is arranged to be pressed through a portion of the item to be protected and inserted into the clutch of the other component. The clutch is arranged to hold the pin until an externally applied magnetic force releases opens the clutch, thereby releasing the pin. The unlocking of a magnetically actuated locking mechanism is typically accomplished by the check-out clerk bringing the hard tag to a location at the checkout counter where a powerful magnetic field is generated to release the clutch. Thus, the hard tag can be removed from the item to be sold, so that when the item is carried past the antenna system at the exit of the store, there is no tag on the to set off an alarm. Other devices for releasable (e.g., lockable) attachment to an item to be protected are so called “safers” and “spiders.” One example of a safer is shown in copending U.S. patent application, Ser. No. 11/154,252, filed on Jun. 16, 2005, entitled Self-Check System and Method For Protecting Digital Media, which is assigned to the same assignee as this invention and whose disclosure is incorporated by reference herein. The safer shown therein is merely exemplary of various types of safer devices that the subject lock system can be used with. A “spider” basically comprises an alarm tag with one or more retractable cable lanyards by which it is affixed to merchandise to be protected.

While the foregoing EAS and RFID tag systems are generally suitable for their intended purposes, they still leave much to be desired from the standpoint of effectiveness. For example, many prior art EAS/RFID systems are particularly susceptible to avoidance by employees of the store, e.g., the employees may remove or otherwise disable the tag. One particular avoidance scheme is known as “sweethearting.” In the context of deactivatable EAS tags, such action can be accomplished by the checkout clerk deactivating the tag on an item (but not ringing up the sale on the register), so that the item can be taken from the store without producing an alarm.

For hard tags sweethearting can be accomplished by the check-out clerk placing the hard tag within the magnetic field to release the clutch and thereby enable the tag to be removed, but not ringing up the sale. To minimize the chances of sweethearting of items to be protected with hard tags, so-called an authenticated detachment systems have been proposed. One type of system is that disclosed in U.S. patent application Ser. No. 11/060,839, filed on Feb. 18, 2005, entitled System and Method for Authenticated Detachment of Product Tags, which is assigned to the same assignee as this invention and whose disclosure is incorporated by reference herein. Such authenticated detachment systems basically comprise hard tags including an RFID circuit. The magnetic detacher, i.e., the device that magnetically releases the ball clutch of the tag, includes an RFID reader. Such a system can be operated so that it will only permit the detacher to release the tag (or prevent the system from setting off an alarm if the tag remains on the item) if the tag is read into the register or the store's computer system.

Avoidance of tag detection systems can also be achieved by use of various types of anti-detection devices, depending upon the type of security tag used. For example, if the tag is in the form of a label or sticker including a resonant circuit, some thieves may make use of metal-foil-lined bags into which the tagged pilfered merchandise can be placed so that the electronic system for detecting the tag is unable to do so. If the tag is a hard tag, some thieves may make use of a powerful magnet which they carry to release the clutch mechanism of the hard tag to permit them to remove the hard tag before they attempt to take the item out of the store.

Another commonly used technique used to protect items from theft is to lock particularly susceptible items, e.g., small, high-value items, in a pilfer-proof environment, e.g., in a cage or some other secure structure within the retail establishment. While the use of a locked environment has some advantages from a security standpoint to reduce theft, it has various disadvantages from a merchandising standpoint. In particular, the use of a locked, restricted environment may impede the sales of the item by making it difficult for consumers to put their hands on the item to examine it. Moreover, the use of locked environment for items to be sold presents various complications and concomitant problems resulting from the inherent need for keys, particularly physical keys, to unlock the secure environment(s) where the items are held.

The same holds true for items to be protected during transportation, e.g., by truck containers from the warehouse to the retail establishments. Among the various issues that may impede the merchandising of the items stored in locked environments are the following. Are different items to be stored in different secure areas, each with its own key, or will a common key be used? Which employees are to be given the key(s) to the lock(s)? As will be appreciated, If only the manager is given the key in the interest of security, this can significantly impedes sales since many store patrons may not be patient enough to wait until the manager is available to unlock the area to provide access to the items. Other issues and problems inherent with use of physical keys are: what procedure will be followed if a key is lost or stolen? Does (do) the lock(s) have to be changed immediately? If so, is access to the protected area to be off limits to customers until the lock is changed? The same also holds true with respect to items locked in containers, totes or other transportable or static storage devices. For example, with respect to truck containers, will all of the truck containers in the business's fleet have to be brought in for changing the container locks if a key is lost or stolen? These are but a few examples of the problems associated with merchandising products that are stored in locked or secured areas or containers, etc. The elimination of a physical key and its substitution with an electronic key for providing authorized opening signals to an electronically operated lock having some intelligence built into it to recognize an appropriate opening signal can eliminate or minimize some of these merchandising issues, but not all.

The use of RFID technology has been disclosed for effecting the opening of locked items. For example, in U.S. Letters Patent No. 6,957,767 (Aupperle et al.) there is disclosed a mailbox equipped with an RFID reader that is arranged to be powered by a battery or by an electrical line connected to the mailbox. An RFID tag is also provided to continuously transmit a signal which contains an RF identifier. Upon receipt of that signal the RFID reader compares the RF identifier in the signal to an RF identifier assigned to the mailbox. If a match is established, the mailbox is unlocked and access is permitted. The signal transmitted may be encrypted for security. See also, Published United States Patent Application US2005/0156752A1 (Finkenzeller et al.) which discloses as system making use of transponder to send a wireless signal to a device that is arranged to control the opening of a door. That device includes a small battery to power it. When the appropriate signal sent by the transponder is received, the device unlocks the door. While the forgoing lock systems may appear generally suitable for their stated purposes, they require on-board power, e.g., a battery, for the unlocking device to operate, a less than optimal solution.

In order to overcome the above problems and drawbacks of the prior art, a universal locking solution for protecting items from theft or for being a part of a mobile commerce system is needed. The subject invention addresses those needs.

### BRIEF SUMMARY OF THE INVENTION

In accordance with one aspect of the invention a universal lock system is provided. That system basically comprises a remote actuating device and a passive lock. The remote actuating device is preferably in the form of a portable member arranged to wirelessly transmit at least one wireless signal (e.g., radio frequency) to the lock. The lock comprises an acuatable trigger mechanism, and a control circuit. The trigger mechanism, when actuated, enables the lock to be opened, and wherein the control circuit is adapted to receive the at least one radio frequency signal from the portable member for electrically powering the control circuit. The control circuit is also arranged to determine if the at least one radio frequency signal is appropriate to unlock the lock, whereupon the control circuit produces a trigger signal. The trigger mechanism is coupled to the control circuit and is responsive to the trigger signal to enable the lock to be unlocked.

In accordance with another aspect of this invention a protection system comprising a lock system and a structure, e.g., a static structure or portable/movable structure, such as a container for holding one or more plural items, to be protected by a lock is provided. The lock system is preferably constructed as set forth above.

In accordance with still another aspect of this invention a method for protecting a structure (e.g., static or portable/movable) by use of a lock system is provided. The method basically entails providing a lock system that is preferably constructed as set forth above and coupling that system to the structure to be protected.

### BRIEF DESCRIPTION OF SEVERAL VIEWS OF THE DRAWINGS

The invention will be described in conjunction with the following drawings in which like reference numerals designate like elements and wherein:

FIG. 1 is a schematic view of one exemplary embodiment of a locking system constructed in accordance with the subject invention;

FIG. 1A is a functional diagram of the lock shown in the exemplary embodiment of FIG. 1;

FIG. 1B is a functional diagram of the electronic key shown in the exemplary embodiment of FIG. 1;

FIG. 1C is a block diagram of an exemplary “smart card” core module that forms a portion of the on-board electronics for the electronic key and for the lock shown in the exemplary embodiment of FIG. 1;

FIG. 2 is an exploded view of a hard tag forming a part of an exemplary locking system, like that of FIG. 1, shown protecting a garment from theft;

FIG. 3 is an isometric view of a safer forming a part of an exemplary locking system, like that of FIG. 1, shown protecting a CD or DVD from theft; and

FIG. 4 is a block diagram of various devices which may make use of the subject invention and showing various structures (static and portable/movable) for which the locking system of the invention can be used.

### DETAILED DESCRIPTION OF THE INVENTION

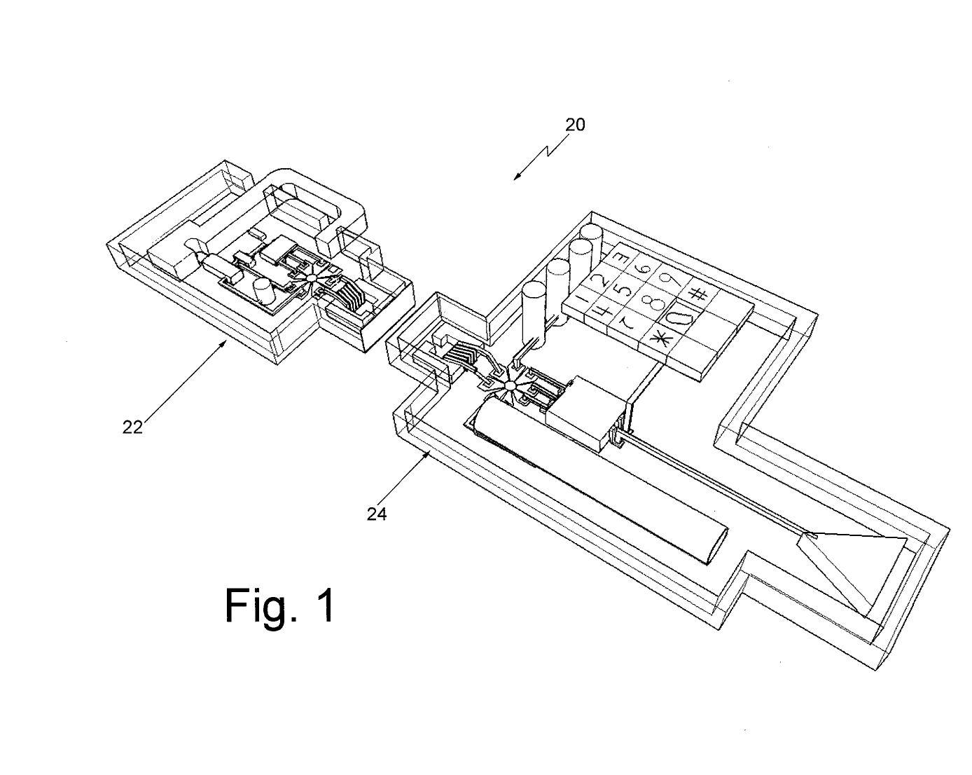

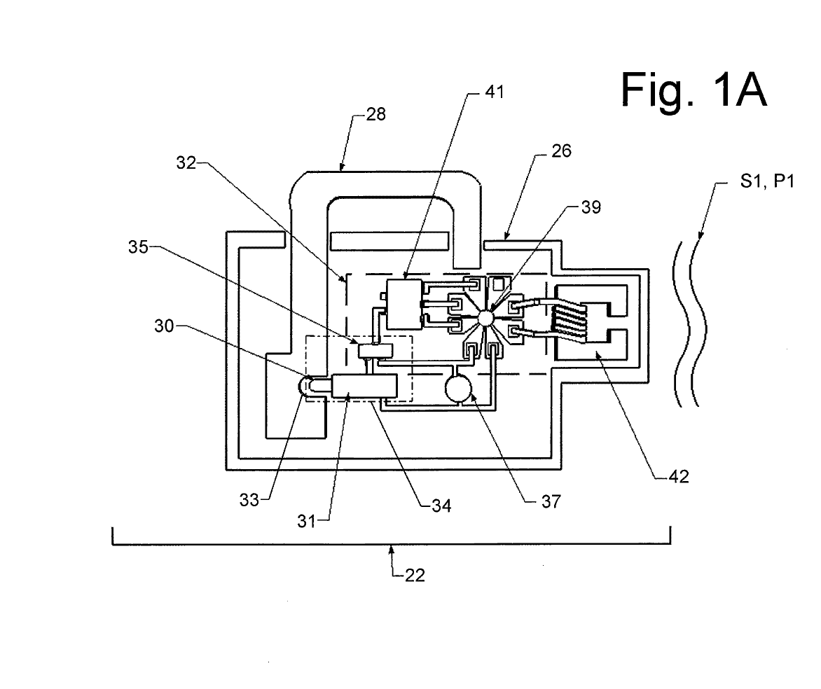

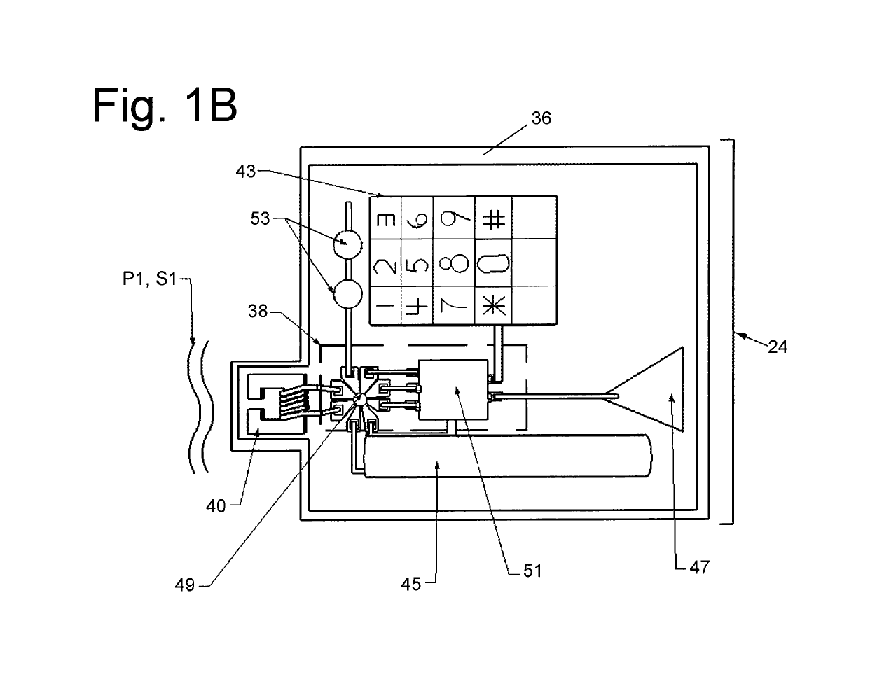

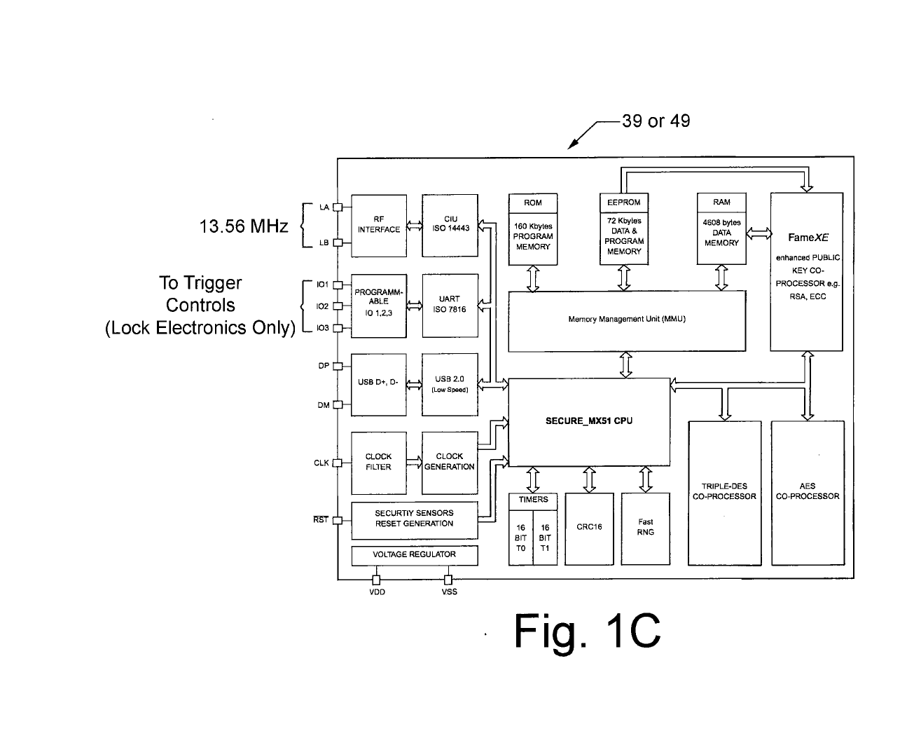

Referring now to the various figures of the drawing wherein like reference characters refer to like parts, there is shown in FIG. 1 a universal lock system 20 constructed in accordance with one exemplary embodiment of this invention. By “universal,” it is meant a system including low cost, robust, strong portable lock 22 and a remote, electronically operative device or “key” 24 for operating, e.g., opening, the lock. The electronic key 24 is arranged to communicate wirelessly with the lock 22. Such wireless communication for purposes of the present invention 20 comprises radio frequency (RF) signals in the range of approximately 100 kHz to 6 GHz. In addition, and in accordance with a preferred aspect of this invention, the electronic key is also arranged to wirelessly communicate with any computer system (not shown) of a business, such as a cash register, the inventory management and control system, etc. Although less preferred, the communication between the electronic key and the computer system can be other than wirelessly, e.g., it can be by connection a hardwired network connection or by physical connection to a port on the computer network, etc.

The portability of the lock 22 enables it to used anywhere and then readily moved to another location for use thereat. The system 20 is not limited to use to protect items from theft. In this regard as will be appreciated by those skilled in the art from the discussion to follow, the system 20 can be used to form a relatively low cost access control system, since the lock(s) to restrict access to an area need not be built into the structure housing the restricted area. Moreover, the system 20 can also form a portion of a mobile commerce system.

As clearly seen in FIG. 1, the exemplary lock 22 is similar in construction in many respects to a conventional lock, e.g., a padlock, except for some very significant differences (to be described later). It should be pointed out at this juncture that locks can be constructed in accordance with this invention that are not of the padlock type. Thus, this invention contemplates any type of lock which is arranged to be opened or unlocked either manually or automatically when an appropriate signal is received from the key. Before discussing the details of the exemplary lock 22, a brief description of a conventional padlock is in order. To that end a conventional padlock basically comprises a housing, a movable bar (e.g., a U-shaped member) connected to the housing and which is arranged to be moved with respect to the housing between an open and closed position and vice versa, a tumbler mechanism which is located in the housing and constitutes the interpreter for the lock's key so that the lock “knows” which key to allow and which to deny, a trigger which responds to the tumbler mechanism sensing the appropriate key being in place and a latch coupled to the trigger to hold the bar securely in place (closed) until the latch is actuated by the trigger in response to the appropriate key cooperating with the tumbler mechanism. The housing constitutes the case for the lock that keeps the latch, trigger, and tumblers free from tampering.

The exemplary lock 22 of this invention is like a conventional padlock in that it includes a case or housing 26, a movable bar 28, and a latch 30 which forms a portion of a trigger mechanism 34. The latch 30 can be of any suitable construction. In the exemplary embodiment shown, the movable bar 28 is prevented from displacement away from the housing 26 due to the presence of the latch 30 in a cavity 33 in the bar 28. By way of example only, the trigger mechanism 34 may comprise a spring loaded device, which stores potential energy when the bar is closed, i.e., the mechanical force applied to close the bar 28 so that it is locked is transferred to the trigger 31 where it is stored for later use (release) to unlock the bar 28 when triggered (as will be described later). Alternatively, the trigger mechanism 34 may include electronic control of the latch 30 and, as such, may also comprise a trigger control 35 portion for controlling the trigger 31 to extend or withdraw the latch 30.

Unlike a conventional lock, the lock 22 includes on-board circuitry 32, e.g., an RFID circuit, enabling the lock's bar to be opened when provided with an appropriate wireless signal (e.g., a 13.56 MHz radio frequency signal like that used in EAS and RFID systems). The wireless signal is provided from the remotely located electronic key 22. The electronic key 24 may take various forms. For example, it may be in the form of a cellular phone, PDA, laptop computer or any other wireless transmitter that is preferably (but not required to be) hand-holdable. The electronic key 22 includes circuitry to enable it to perform its various functions, e.g., to communicate wirelessly with the lock 22 to operate it by either the key 24 offering a password to the on-board circuitry 32 of the lock 22 or by the key 24 providing an authenticated response to a signal received wirelessly from the on-board circuitry 32 of the lock 22. In addition, the on-board circuitry 38 (see FIG. 1B) of the electronic key 24 preferably enables the key 22 to communicate wirelessly with the store's data collection system or with other computer systems to collect data, such as when the lock was opened, what key opened the lock, etc.

Furthermore, the on-board lock electronics 32 is electrically coupled to an antenna 42 for receiving and transmitting wireless signals, such as power P1 from the electronic key 24, as well as data S1.

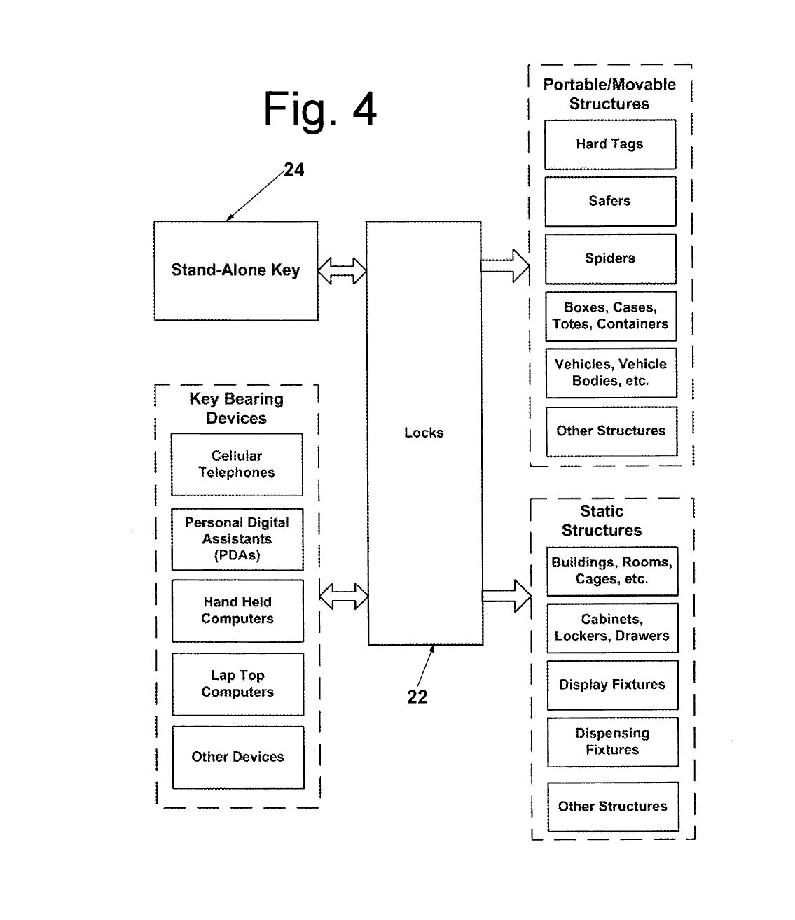

The lock's on-board circuitry 32 is preferably programmable to enable the lock 22 to be used for numerous applications such as shown in FIG. 4 and with numerous actuation codes.

Those codes can be preprogrammed into the circuitry or changed “on-the-fly” (wirelessly transmitted to the circuitry). Cryptographic and other electronic security features are preferably included in the lock, via its on-board circuitry 32. Further still, the on-board circuitry 32 is preferably able to provide wireless signals back to the electronic key 24 indicating its operating and usage parameters, e.g., when the lock was opened, by whom, under what conditions, etc. This feature enables the lock to be an integral part of a data collection system for keeping track of inventory, personnel, suppliers, etc. or as part of a mobile commerce system. It should be further noted that this time-date stamping and identity-of-user function of the electronic key 24 provides a crucial feature of the present invention: eliminating undocumented use of the lock 22. In other words, a person trusted or authorized to use the electronic key 24 to open the lock 22, may still choose to, or unknowingly, be part of an unauthorized act. The fact that the every key-lock interaction is recorded, provides an important deterrent since the recordation of the key-lock interaction event automatically occurs.

Preferably, the lock 22 is a passive component, i.e., having no on-board power, but instead relies on power transmitted wirelessly to it from the electronic key 24 or some other wireless transmitter. While a totally passive lock is preferred, it is never the less contemplated that the lock 22 could include a very long-lived, very low power battery (not shown) for powering all or a portion of the circuitry of the lock over a very long period of time (e.g., years), without necessitating battery replacement. Alternatively, the lock 22 can include a passive power accumulator 37 to store the energy wirelessly transmitted to it by the electronic key 24 for subsequent use.

In any case, since the opening of the lock 22 is preferably achieved by means of very low power, as mentioned previously, the lock 24 includes a trigger mechanism 34 that is arranged to be actuated by very low power. The trigger mechanism 34 comprises a trigger control 35, a trigger 31 and the latch 30. The trigger 31 is arranged to be responsive to an actuation or trigger signal (indicating that the lock should be opened) from the trigger control 35 to activate the trigger 31 to retract the latch 30 to enable the bar 28 of the lock 22 to be opened. It should be understood that the trigger control 35 emits the trigger signal to the trigger 31 only when the on-board electronics 32 is satisfied that an authorized person is using the key 24 based on the communication occurring between the on-board lock electronics 32 and the on-board key electronics 38.

As shown in FIG. 1A, the on-board lock electronics 32 acts as a transceiver and basically comprises a “smart card” core module 39 and a core interface 41. The smart card core module 39 processes the incoming RF signal from the electronic key 24 and, in conjunction with the core interface 41 (which is an internal input/output encoder/decoder), analyzes the data (including decryption) in the signal to determine whether to have the trigger control 35 activate the trigger 31 or not. FIG. 1C depicts an exemplary “smart card” core module 39 and, by way of example only, this may be implemented using a Philips Semiconductor P5CT072 Secure Triple Interface PKI Smart Card Controller, or any other suitable electronic circuit. The core module 39 in the lock electronics 32 comprises memory containing a plurality of passwords and other authenticating details which are pre-stored and that are used by the core module 39 and core interface 41 to analyze the data received from RF signal from the electronic key 24 in order to determine whether to activate the trigger control 35 or not. As mentioned earlier, there may be a series of bi-directional wireless communications between the lock 22 and the electronic key 24 in order to establish the authenticity of the user holding the key 22; thus, the core module 39/core interface 41 operate to generate encoded authenticity questions for the holder of the key 22 which, in turn, responds with encoded responses. Only if the lock electronics 32 are satisfied with the answer, will the core interface 39 activate the trigger control 35 to release the moveable bar 28.

As noted above the electronic key 24 can be a stand-alone unit or part of any key bearing device, such as shown in FIG. 4. For example, it may be any suitable member, such as a cellular telephone, PDA, hand-held or laptop computer, or a dedicated component that can be worn by a person on his/her wrist, or suspended from the person's neck by a lanyard, or on a card that can be carried in a wallet or purse, etc. In the interests of drawing simplicity an exemplary electronic key 24 is shown in FIG. 1B. The electronic key 24 comprises a housing 36 which contains the on-board electronics 38, a first antenna 40, keypad/display 43, a power source 45, a second antenna 47, and a plurality of indicators 53 (four of which are shown in FIG. 1 and only two of which are shown in FIG. 1B). The power source 45 may comprise a battery (e.g., large NiCAD battery), which may also be rechargeable, for powering the key's on-board electronics and indicators. The battery 45 also provides the electrical power P1 that is transmitted wirelessly to the lock 22 to power the lock 22. It should be pointed out that the power P1 that is wirelessly transmitted to the lock to operate it, need not be electrical power. Thus, the power P1 could be in the form of electromagnetic radiation such as light, a magnetic field, or microwaves, etc; it may also be ultrasonic power. In such alternative arrangements, the electronic key 24 will include some means for producing the alternative wireless power signal and the lock will include some means to convert the alternative wireless power signal into an electrical signal for use by the lock's electrical circuitry.

The keypad/display 43 comprises any conventional input/output (I/O) device that a user can read and manipulate in order to respond to the interrogation/communication that is initiated between the electronic key 24 and the lock 22. A plurality of indicators 53 (e.g., light emitting diodes) may be provided to prompt the key user in responding to inquiries from the lock 22 and/or may supplement the keypad/display 43 responses by providing a status as to the condition of the lock 22 (e.g., lock is awaiting a response from the key 24, low power on the key 24, lock is currently unlocked, lock is currently locked, etc.). As with the lock's on-board electronics 32, the key's on-board electronics 38 (which also acts a transceiver) comprise an encryption core 49 and a central processing unit (CPU) 51. Together, the encryption core 39 and the CPU 51 cooperate to generate encoded data signals, based on user inputs from the keypad/display 43, in order to provide the wireless data signal S1 in response to inquiries from the lock 22, as well as providing decryption functions for signals received from the lock's on-board electronics 32. Thus, the first antenna 40 is electrically coupled to the encryption core 49. It should be noted that an exemplary core module 49 for use by the key electronics 38 is similar, although not identical, to the one depicted in FIG. 1C. Thus, the key's on-board circuit 38 serves as a transceiver to send control and data signals S1 to the lock 22 and to receive electrical signals from the lock 22. To that end, the antenna 40 is provided as part of the transceiver. It should be pointed out at this juncture that the signals S1 that are sent by the transceiver's antenna 40 to the lock 22 can also be used to power the on-board circuitry 32 of the lock 22 in addition to providing that circuitry 32 with the data and control information, so that the power signal P1 is not needed.

As mentioned earlier, when the key-lock interaction event occurs, the details (e.g., time, date, user, etc.) of this event are automatically recorded. This is achieved by having the key 24 automatically transmit such data to a remotely-located receiver/database (not shown) via the second antenna 47 (e.g., a WiFi antenna). The wireless signals transmitted to this receiver/database are also encoded using the key's on-board electronics 38.

Thus, besides pre-storing passwords into the lock's on-board electronics 32, specific personal details may also be stored into the lock's on-board electronics 32 that only a particular user would know. As a result, during the authentication communication occurring between the lock 22 and the key 24, the inquiry to the key 24 user may be a personal question such as the maiden name of his/her mother. It should be pointed out that the transmission of the data to the remotely-located receiver/database need not be accomplished via the second antenna 47. Thus, it is contemplated that the data may be transmitted by the antenna 40. Moreover, it is contemplated that the key 24 may be brought to some location where its data can be downloaded via a hardwired connection for use by the remotely-located receiver/database.

As mentioned above the latch 30 of the lock 22 may comprise a spring loaded device.

However, it can be of other constructions, each of which being arranged to store considerable mechanical energy in it and which is available for release when triggered by the trigger mechanism 34. This arrangement allows the lock to automatically open itself upon being triggered. In this regard, in the exemplary embodiment shown, the latch 30 is coupled to the movable bar 28 so that when that bar is manually closed by a user, the mechanical force applied to close the bar applies energy to load the spring of the latch. That spring in turn stores the energy as potential energy available for release when the latch is triggered (actuated) by the trigger mechanism 34. It should be pointed out at this juncture that it is contemplated that for some applications the latch 30 need not store sufficient energy to open the lock's bar 28 by itself, but merely store enough energy to release the latch 30 so that the lock's bar can be manually opened, e.g., the bar 28 pulled away from the housing 26 by a user. Alternatively, the trigger mechanism 34 may include inductive actuation.

As mentioned above, the trigger mechanism 34 is preferably arranged to be capable of operation with very low power. Moreover, and quite significantly, the trigger mechanism 34 should only operate in response to an appropriate actuation signal. Thus, it should be immune to spurious activation or triggering caused by external mechanical forces, such as shock, vibration, temperature change, etc., and/or external electromagnetic and other conditions, e.g., temperature changes, applied magnetic fields, etc.

Various types of trigger mechanisms 34 can be utilized in this invention providing that they are capable of operating in response to an electrical signal, e.g., they may constitute electrical to mechanical transducers. In this regard it is contemplated that the triggers may make use of artificial muscles, polymeric gel actuators and electroactive polymer transducers. Triggers based on piezo electric crystals, Hall effect devices, and eddy current technologies may also be used. Examples of artificial muscle and polymeric actuators are found in U.S. Letters Patent Nos. 5,250,167 (Adolf et al.); 5,389,222 (Shahinpoor); 6,475,639 (Shahinpoor et al.); and 6,876,135 (Pelrine et al) and all of whose entire disclosures are incorporated by reference herein.

The locks of the subject invention can be used with portable or transportable structures, e.g., hard tags, safers, spiders, boxes, cases, totes, cargo containers, truck bodies, etc. It can also be used with static structures, such as buildings, rooms in buildings, cages, cabinets, drawers, lockers, display fixtures, dispensing fixtures or other structures as shown in FIG. 4.

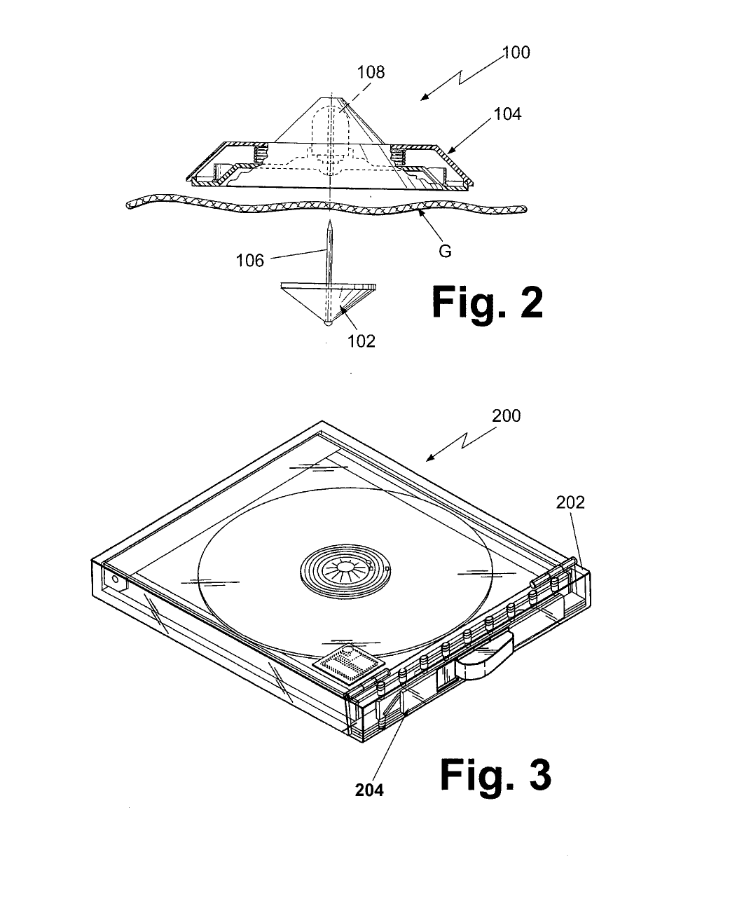

In FIG. 2 there is shown a hard tag 100 making use of a lock (not shown) constructed in accordance with this invention for protecting an article of merchandise, e.g., a garment, from theft. The hard tag 100 is similar in construction to that disclosed in copending U.S. patent application Ser. No. 10/848,339 filed on May 18, 2005, entitled EAS/RFID Identification Hard Tags, which is assigned to the same assignee as this invention and whose disclosure is incorporated by reference herein. The hard tag 100 basically comprises two interlocking components 102 and 104 which include a lock constructed in accordance with the teachings of this invention. The component 102 includes a pin 106 that is arranged to pierce through the article to be protected, e.g., a garment G. The component 104 houses the lock of this invention and in particular the circuitry 32 (not visible in FIG. 2), the trigger mechanism 34 (also not visible in FIG. 2) and the latch 30 (also not visible in FIG. 2). The latch forms a portion of a magnetically activatable clutch 108 which is arranged to receive and trap the pin 106 of the component 102, thereby securing the two components 102 and 104 together on the garment. The hard tag is arranged to operate as follows. When the lock's on-board circuitry receives a wireless signal from the electronic key 22 (FIG. 1) and that signal is decoded and determined to be a valid one, the trigger mechanism of the lock will be actuated thereby releasing a latch, which in turn releases the clutch 108 to enable the two components to be separated from each other and the hard tag to be removed from the garment.

In FIG. 3 there is shown an exemplary “safer” or storage box 200 making use of a lock constructed in accordance with this invention for protecting an article of merchandise, e.g., a CD or DVD, from theft. The safer is similar in construction to that disclosed in copending U.S. patent application Ser. No. 11/154,252, filed on Jun. 16, 2005, entitled Self-Check System and Method For Protecting Digital Media, which is assigned to the same assignee as this invention and whose disclosure is incorporated by reference herein. That device basically comprises a case 202 having a pivotable or hinged access door 202 at an end of the case. The door is arranged to be locked in the position shown in FIG. 3 by a lock 204. The lock 204 is constructed in accordance with this invention, but is not of the padlock type, like shown in FIG. 1, but rather comprises a pair of sleeves, a pair of ferromagnetic locking tongues and a locking bar. The sleeves and locking tongues together make up the latch mechanism to effect the movement of the bar. The bar holds the door in the closed position shown in FIG. 3 to prevent access to the CD or DVD located therein. The locking bar itself comprises a pair of notches that correspond to a pair of protrusions in the tongues. When the cover of the security box 200 is closed, and the locking bar slid downward through the sleeves, the protrusions are biased into the notches, thereby locking the cover in place. The lock 204, like the locks disclosed above, also includes the circuitry 32 (not visible in FIG. 3) and the trigger mechanism 34 (also not visible in FIG. 3). The lock 204 is arranged to operate as follows. When the lock's on-board circuitry receives a wireless signal from the electronic key 22 (FIG. 1) and that signal is decoded and determined to be a valid one, the trigger mechanism of the lock will be actuated thereby releasing a latch, which in turn causes a magnet (not shown) in the cover to move the ferromagnetic tongues toward the magnet, thereby disengaging from the notches and freeing the locking bar. The cover of the box can then be pivoted open to provide access to the CD/DVD.

It should noted that other uses of the electronic key 24/lock 22 system can be incorporated at earlier stages of the merchandising chain such as to logistic totes, i.e., containers of merchandise shipped from warehouses to outlets. Also, the electronic key 24/lock 22 system can be used in display fixture modes, i.e., at the retail shelf level where customers can handle or manipulate an item but cannot remove it from the store location due to the item being electronically tethered to the store shelf. This configuration can also be used in process interlocks, e.g., machinery that may cause injury or damage products during manufacture by requiring authentication from a machine user in order to energize or de-energize (rather than preventing or gaining access via a lock). This same configuration can be adapted for vehicle ignition/operation.

As mentioned earlier, the lock 22 need not be of the padlock type construction like that shown and described above, but can take any configuration and construction wherein it is a portable, passive device having some component which is arranged to be moved to open, when actuated, with the actuation being accomplished by means of a very low power trigger. Moreover, the locks and locking systems of this invention are not limited to the security uses discussed above. Thus, this invention is applicable to mobile commerce. For example it is contemplated that a person with a cellphone or other hand-held, wireless device can go to a dispensing or vending machine equipped with a lock constructed in accordance with the teachings of this invention, to purchase an item in that machine by inputting appropriate information into the cellphone. The cellphone would then transmit the transaction data, e.g., purchase price, item purchased, etc., the credit card system of that person to debit his/her account. Once the transaction is approved, the credit card system would transmit an authorization signal to the cellphone, which in turn will produce and transmit an appropriate signal to the dispensing/vending machine to cause the lock associated with the particular item to be dispensed to open and thereby release the item to the customer. Moreover, the circuitry in the lock can also be used to transmit information, e.g., status of inventory in the machine, etc., to the computer system of the dispensing machine operator.

As should be appreciated from the foregoing, the locks and locking system of this invention provide a very inexpensive and reliable universal device that can readily be used in place of hard tag locks, padlocks, display fixture locks and dispenser locks. For example, in a retail business, locks 22 can be installed at front doors, points of sale, security offices, “employee only” doors, stock rooms, loading docks, etc. This is accomplished through the use of a very inexpensive “tumbler” (e.g., a variation of an RFID tag chip), a reliable low-power actuated trigger and a potential energy storing latch in a passive lock that is operated and powered remotely from an electronic key. Moreover, the electronic key of this invention can be a universal device for wirelessly communicating with the locks to open them and transmit and receive data from them and for communicating with any computer system. Thus, the subject invention enables one to create an overall system suitable for providing information in the form of a comprehensive log of who has/is opening the locks, including when, where under what circumstances and condition. Moreover, the system of this invention provides effective and efficient key management, so that authority to open the locks can be altered in real time. Thus, the system of this invention effectively solves many, if not all, of the key, key management, tumbler, tumbler setting, and use tracking issues inherent in prior art locking system.

In view of the all of the foregoing, it should be appreciated that the system 20 of the present invention provides for:

a simple, flexible, universal locking platform;

a simple, intuitive, automatic key management regime;

forensic quality data collection of fair and unambiguous data;

a modular deployment solution that can be adjusted to the economics of a customer's use.

Moreover, it should also be understood that the present invention 20 is a radical departure in concept from the conventional idea of a lock system. In this regard, in conventional lock systems, the locking mechanism is typically the most expensive and elaborate portion of the locking system whereas the key, if a typical key with a toothed shank, is the most inexpensive part of the lock system. The cost of installing a plurality of these expensive locks, with associated keys, can easily exceed the budget of the owner. In addition, possession of a particular key determines who can gain access to the corresponding lock. Thus, managing of (and the unauthorized copying thereof) such keys also presents an even larger problem. In contrast, the present invention 20 reverses this entire paradigm. The system 20 can comprise one or a plurality of inexpensive passive locks 22 with a single complex key 24, or a limited number of such complex keys 24, all of which is/are not cost prohibitive to the business owner. Furthermore, from a security standpoint, possession of the key 24 is not determinative of controlling access to the locks 22 because the software configuration of the key 24 is controlled by another entity, e.g., the business owner or headquarters, etc. If desired, the business owner or headquarters can immediately change (or implement a time limit on) the key's 24 software configuration, or the lock's 22 software configuration, thereby disabling the key 24, or rendering it useless, regardless of who has possession of it.

All of the prior art references and pending application identified in this application are incorporated by reference in their entireties.

While the invention has been described in detail and with reference to specific examples thereof, it will be apparent to one skilled in the art that various changes and modifications can be made therein without departing from the spirit and scope thereof.

What is claimed is:

1. A lock system comprising a remote actuating device and a passive lock, said remote actuating device comprising a portable member arranged to wirelessly transmit at least one radio frequency signal to said lock, said lock comprising an acuatable trigger mechanism, and a control circuit, said trigger mechanism, when actuated, enabling said lock to be opened, said control circuit being adapted to receive said at least one radio frequency signal from said portable member for electrically powering said control circuit, said control circuit also being arranged to determine if said at least one radio frequency signal is appropriate to unlock said lock, whereupon said control circuit produces a trigger signal, said trigger mechanism being coupled to said control circuit and responsive to said trigger signal to enable said lock to be unlocked.

2. The lock system of claim 1 wherein said trigger mechanism is responsive only to said trigger signal.

3. The lock system of claim 1 wherein said at least one radio frequency signal operates in the range of approximately 100 kHz to 6 GHz.

4. The lock system of claim 1 wherein said control circuit comprises a smart card core module and a core interface, said core module and said core interface cooperating to analyze said at least one radio frequency signal to determine if said trigger signal should be produced.

5. The lock system of claim 1 further comprising an energy storage mechanism, said energy storage mechanism being arranged to store potential mechanical energy therein and to release said energy when triggered by said trigger mechanism.

6. The lock system of claim 1 wherein said at least one wireless signal provides power to said trigger mechanism to enable said trigger mechanism to actuate.

7. The lock system of claim 1 wherein said at least one wireless signal comprises two signals, one for powering said control circuit and one for powering said trigger mechanism.

8. The lock system of claim 5 wherein said energy storage mechanism is arranged to store potential energy therein upon the closure of said lock.

9. The lock system of claim 1 wherein said trigger mechanism is an electrical to mechanical energy transducer.

10. The lock system of claim 9 wherein the electrical to mechanical energy transducer selected from the group consisting of artificial muscles, piezo electric devices, and Hall effect devices.

11. The lock system of claim 1 wherein said portable member is selected from the group consisting of cellular phones, portable digital assistants, hand-held and laptop computers.

12. The lock system of claim 5 wherein said energy storage mechanism, said trigger mechanism and said control circuit are all located within a housing, said housing being arranged to enable said wireless signal from said portable device to pass through said housing to said control circuit.

13. The lock system of claim 12 wherein said housing is resistant to physical intrusion.

14. The lock system of claim 1 wherein said wireless signal comprises radio frequency energy including at least one lock related code and wherein said portable member comprises an antenna for wireless transmitting said wireless signal to said lock and wherein said control circuit comprises a RFID circuit.

15. The locks system of claim 14 wherein said at least one radio frequency signal operates at approximately 13.56 MHZ.

16. The lock system of claim 14 wherein said portable member is arranged to store therein plural lock related codes and wherein the lock related codes are managed by said portable member.

17. The lock system of claim 1 wherein said system provides data indicating the one or more of who used the lock, where the lock was used, when the lock was used and how the lock was used.

18. The lock system of claim 1 wherein said control circuit includes encryption means.

19. The protection system of claim 1 wherein said portable member is arranged to store therein plural lock related codes and wherein the lock related codes are managed by said portable member.

20. A protection system comprising a lock system and a structure to be protected by a lock, said lock system comprising a remote actuating device and a passive lock, said remote actuating device comprising a portable member arranged to wirelessly transmit at least one wireless signal to said lock, said lock comprising an actuatable trigger mechanism and a control circuit, said trigger mechanism, when actuated, enabling said lock to be opened, said control circuit being adapted to receive said at least one radio frequency signal from said portable member for electrically powering said control circuit, said control circuit also being arranged to determine if said at least one radio frequency signal is appropriate to unlock said lock, whereupon said control circuit produces a trigger signal, said trigger mechanism being coupled to said control circuit and responsive to said trigger signal to enable said lock to be unlocked.

21. The protection system of claim 20 wherein said at least one wireless signal provides power to said trigger mechanism to enable said trigger mechanism to actuate.

22. The protection system of claim 20 wherein said at least one wireless signal comprises two signals, one for powering said control circuit and one for powering said trigger mechanism.

23. The protection system of claim 20 wherein said lock is arranged to be coupled to said structure, whereupon said lock precludes access to said structure when said lock is closed.

24. The protection system of claim 23 wherein said structure is arranged to hold a product to be sold.

25. The protection system of claim 24 wherein said structure is portable.

26. The protection system of claim 25 wherein said structure is selected from the group comprising hard tags, safers, spiders, boxes, cases, promotional displays, and promotional dispensers, display racks, vehicle bodies and cargo containers.

27. The protection system of claim 24 wherein said structure is static.

28. The protection system of claim 27 wherein said structure is selected from the group comprising rooms, cages, cabinets, drawers, lockers, display fixtures, and dispensing fixtures.

29. The protection system of claim 22 wherein said portable member is selected from the group consisting of cellular phones, portable digital assistants, hand-held and laptop computers.

30. The protection system of claim 20 wherein said portable member is arranged to store therein plural lock related codes and wherein the lock related codes are managed by said portable member.

31. The protection system of claim 20 wherein said system provides data indicating one or more factors of who used the lock, where the lock was used, when the lock was used and how the lock was used.

32. The protection system of claim 30 wherein said trigger mechanism is an electrical to mechanical energy transducer.

33. The protection system of claim 32 wherein the electrical to mechanical energy transducer selected from the group consisting of artificial muscles, piezo electric devices, and Hall effect devices.

34. The lock system of claim 20 further comprising an energy storage mechanism, said energy storage mechanism being arranged to store potential mechanical energy therein and to release said energy when triggered by said trigger mechanism.

35. A method of protecting a structure by use of a lock system comprising:
(a) providing a lock system comprising a remote actuating device and a passive lock, said remote actuating device comprising a portable member arranged to wirelessly transmit at least one wireless signal to said lock, said lock comprising, an actuatable trigger mechanism, and a control circuit, said control circuit being adapted to receive said at least one wireless signal from said portable member for electrically powering said control circuit, said control circuit also being arranged to determine if said wireless signal is appropriate to unlock said lock, whereupon said control circuit produces a trigger signal, said trigger mechanism being coupled to said control circuit and responsive to said trigger signal to enable said lock to be opened; and
(b) coupling said lock to said structure.

36. The method of claim 35 wherein said at least one wireless signal provides power to said trigger mechanism to enable said trigger mechanism to actuate.

37. The method of claim 36 wherein said at least one wireless signal comprises two signals, one for powering said control circuit and one for powering said trigger mechanism.

38. The method of claim 35 wherein said method comprises protecting a product to be sold.

39. The method of claim 38 wherein the product to be sold is protected by a structure.

40. The method of claim 38 wherein said structure is portable.

41. The method of claim 40 wherein said structure is selected from the group comprising hard tags, safers, spiders, boxes, cases, promotional displays, and promotional dispensers.

42. The method of claim 38 wherein said structure is static.

43. The method of claim 42 wherein said structure is selected from the group comprising rooms, cages, cabinets, drawers, lockers, display fixtures, and dispensing fixtures.

44. The method of claim 35 wherein said portable member is selected from the group consisting of cellular phones, portable digital assistants, hand-held and laptop computers.

45. The method of claim 35 wherein said portable member is arranged to store therein plural lock related codes and wherein the lock related codes are managed by said portable member.

46. The method of claim 35 wherein said system provides data indicating one or more factors of who used the lock, where the lock was used, when the lock was used and how the lock was used.

47. The method of claim 35 wherein said trigger mechanism is an electrical to mechanical energy transducer.

48. The method of claim 47 wherein the electrical to mechanical energy transducer selected from the group consisting of artificial muscles, piezo electric devices, and Hall effect devices.

49. The method of claim 35 wherein said lock comprises an energy storage mechanism, said energy storage mechanism being arranged to store potential mechanical energy therein and to release said energy when triggered by said trigger mechanism.
